(19) United States
(12) Patent Application Publication
(10) Pub. No.: US 2026/0331933 A1
(43) Pub. Date: Oct. 22, 2026

(54) ENERGY STORAGE APPARATUS

(71) Applicant: GS Yuasa International Ltd., Kyoto-shi, Kyoto (JP)

(72) Inventors: Ryuichi ITO, Kyoto-shi, Kyoto (JP); Kiyohiro FUJITA, Kyoto-shi, Kyoto (JP)

(21) Appl. No.: 19/108,983

(22) PCT Filed: Aug. 4, 2023
(86) PCT No.: PCT/JP2023/028591

§ 371 Date: Mar. 5, 2025

(30) Foreign Application Priority Data
Sep. 16, 2022 (JP) 2022-147773

(51) Int. Cl. H02J 7/61; H02J 7/63

(52) U.S. Cl. CPC H02J 7/61; H02J 7/63

(57) ABSTRACT

An energy storage apparatus includes a cell, a changeover circuit located on a current path of the cell, and a control device. The changeover circuit is a circuit that switches output impedance Z of the energy storage apparatus, and the control device switches output impedance of the energy storage apparatus by using the changeover circuit.

### CROSS REFERENCE TO RELATED APPLICATIONS

This application is a National Stage Application, filed under 35 U.S.C. § 371, of International Application No. PCT/JP2023/028591, filed Aug. 4, 2023, which international application claims priority to and the benefit of Japanese Application No. 2022-147773, filed Sep. 16, 2022; the contents of both of which are hereby incorporated by reference in their entirety.

### BACKGROUND

### Technical Field

The present invention relates to a technique for controlling output impedance of an energy storage apparatus.

### Description of Related Art

An energy storage apparatus mounted on an automobile or the like includes a current interrupting device such as an FET. When an abnormality such as overdischarge or overcharge is detected, the energy storage apparatus can be protected by opening the current interrupting device and interrupting current. PCT International Application Publication WO 2019/111872 discloses this type of technique.

### BRIEF SUMMARY

An energy storage apparatus for a vehicle requires different output performances depending on an application, a use situation, and the like. For example, while a vehicle is parked, only small current needs to be output, but in a case where a vehicle is not parked, for example, while the vehicle is traveling, it is necessary to charge and discharge large current as compared with that while the vehicle is parked. Conventionally, since output impedance of an energy storage apparatus is fixed, a structure in which the output performance cannot be changed has been employed. Further, energy storage apparatuses other than those for a vehicle have had a similar problem.

An object of the present invention is to provide an energy storage apparatus with an output impedance switching function.

An energy storage apparatus includes a cell, a changeover circuit located on a current path of the cell, and a control device. The changeover circuit is a circuit that switches output impedance of the energy storage apparatus, and the control device switches output impedance of the energy storage apparatus by using the changeover circuit according to a predetermined condition. The predetermined condition is, for example, an application, a use situation, size of actual capacity, internal resistance, a deterioration state, and the like of the energy storage apparatus.

In the energy storage apparatus, output performance of the energy storage apparatus can be changed by switching output impedance.

### BRIEF DESCRIPTION OF THE FIGURES

FIG. 1 is a side view of an automobile.

FIG. 2 is a perspective view of a battery.

FIG. 3 is an exploded perspective view of the battery.

FIG. 4 is a block diagram illustrating an electrical configuration of the battery.

FIG. 5 is a circuit diagram of a changeover circuit.

FIG. 6 is a diagram illustrating details of a switch circuit.

FIG. 7 is a schematic diagram of the battery.

FIG. 8 is a table summarizing an application and output impedance of the battery.

FIG. 9 is a flowchart of switching control of output impedance.

FIG. 10 is a flowchart of switching control of output impedance.

FIG. 11 is a circuit diagram of a changeover circuit.

### DETAILED DESCRIPTION OF VARIOUS EMBODIMENTS

### Outline of Present Embodiment

(1) An energy storage apparatus according to one embodiment of the present invention includes a cell, a changeover circuit located on a current path of the cell, and a control device. The changeover circuit is a circuit that switches output impedance of the energy storage apparatus, and the control device switches output impedance of the energy storage apparatus by using the changeover circuit according to a predetermined condition. The predetermined condition is, for example, an application, a use situation, size of actual capacity, and the like of the energy storage apparatus.

According to the energy storage apparatus of one embodiment of the present invention, output performances suitable for a predetermined condition can be exhibited by switching of output impedance according to the predetermined condition. For example, in a case of a small current application, current of the energy storage apparatus can be reduced by switching of output impedance to large. In a case of a large current application, by switching of output impedance to small, current easily flows, and sufficiently large current is easily secured.
(2) In the energy storage apparatus according to (1) above, the control device may acquire information on a use situation or information on an application of the energy storage apparatus through communication with a vehicle, and switch output impedance of the energy storage apparatus according to the acquired information.

In this configuration, output impedance is switched according to a use situation and an application of the energy storage apparatus, so that the energy storage apparatus can exhibit output performances according to the use situation and the application. Further, there is an advantage that output performances can be changed each time a use situation of the energy storage apparatus mounted on a vehicle is changed.
(3) In the energy storage apparatus according to (1) above, the control device may acquire information on a type of a vehicle through communication with the vehicle, and switch output impedance of the energy storage apparatus according to the acquired information.

Maximum current required for the energy storage apparatus may vary depending on a type of vehicle. For example, a large vehicle requires larger maximum current than a light vehicle. With this configuration, it is possible to supply maximum current having magnitude corresponding to a type of a vehicle from the energy storage apparatus to the vehicle. For this reason, there is an advantage that the energy storage apparatus can be used for general-purpose use in different types of vehicles. The type of vehicle is not limited to a light automobile and a large automobile, and may be any type as long as vehicles having different required maximum currents are classified.
(4) In the energy storage apparatus according to (1) above, the control device may include a storage unit that stores information on an application or information on size of actual capacity of the energy storage apparatus, and switch output impedance of the energy storage apparatus according to information on an application or size of actual capacity of the energy storage apparatus stored in the storage unit.

In this configuration, output impedance of the energy storage apparatus can be switched according to an application and size of actual capacity of the energy storage apparatus. For this reason, the energy storage apparatus can exhibit output performances according to an application or size of actual capacity. This configuration has an advantage that the energy storage apparatus can autonomously change output impedance even in a case where there is no communication function with a host device such as a vehicle.
(5) In the energy storage apparatus according to (1) above, the control device may switch output impedance of the energy storage apparatus according to internal resistance or a deterioration state of the cell.

According to this configuration, by switching output impedance according to internal resistance of the cell, total resistance of the energy storage apparatus can be easily kept constant regardless of lapse of time after manufacturing or increase in internal resistance due to use for many years. For this reason, heat generation can be suppressed while power supply capability to a load is maintained. A configuration in which output impedance of the energy storage apparatus is switched according to a deterioration state also has a similar effect.
(6) In the energy storage apparatus according to any one of (1) to (5) above, the changeover circuit may be a plurality of energization circuits connected in parallel, the plurality of energization circuits may have different line resistance, and the control device may switch output impedance of the energy storage apparatus by selection or combination of the energization circuits.

In this configuration, output impedance of the energy storage apparatus can be switched by selection or combination of the energization circuits. Further, since current can be cut off by turning off the entire energization circuits, the configuration can also be used as a protective device of the energy storage apparatus.

### First Embodiment

### 1. Description of Battery

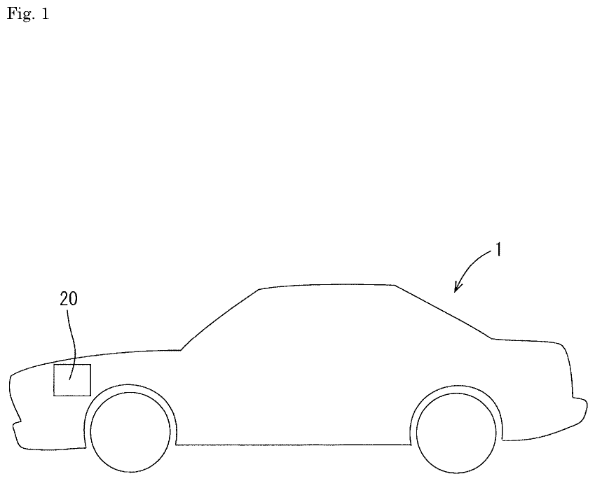

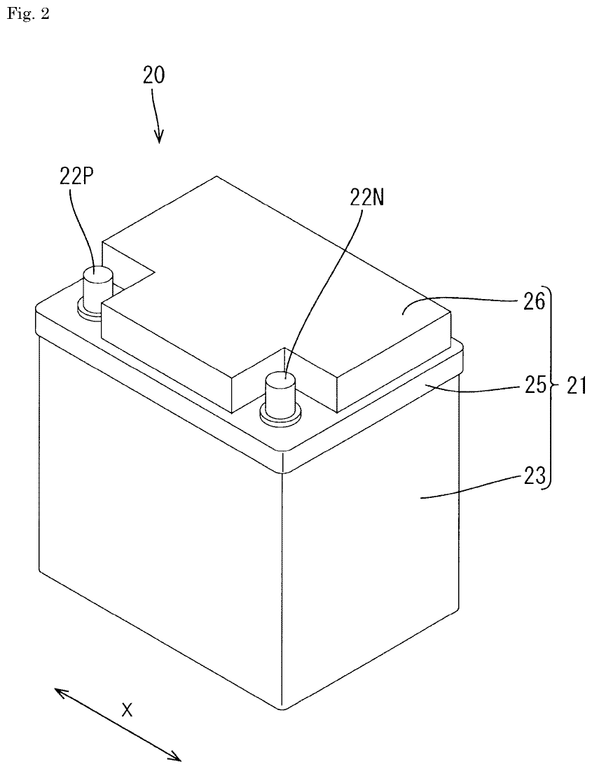

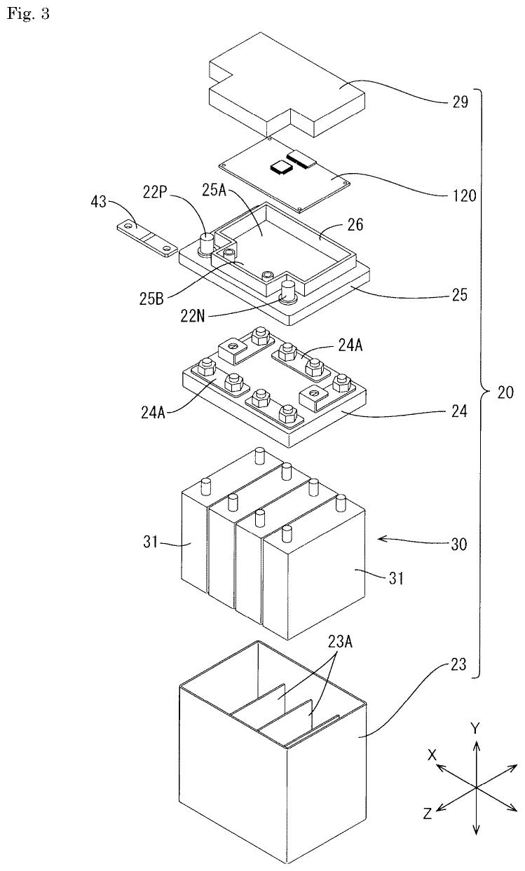

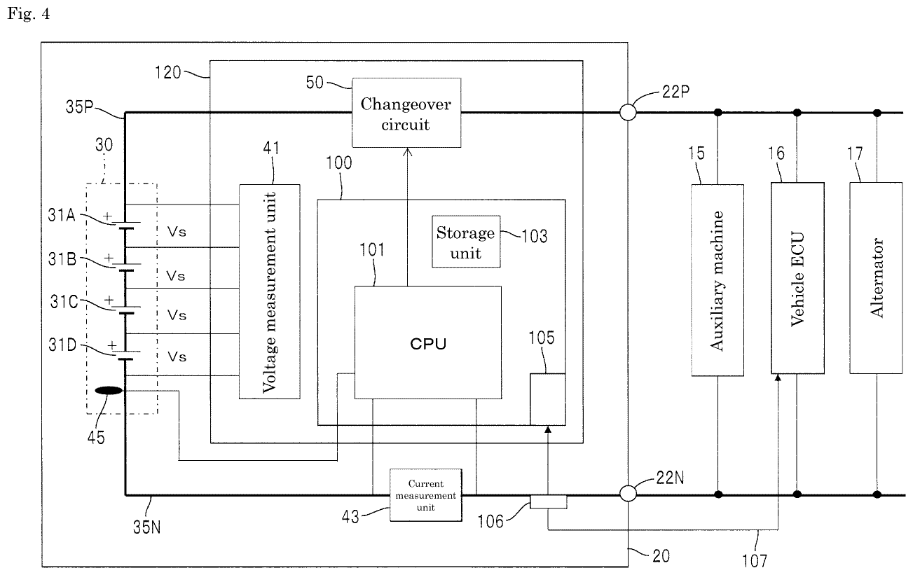

FIG. 1 is a side view of an automobile, FIG. 2 is a perspective view of a battery, FIG. 3 is an exploded perspective view of the battery, and FIG. 4 is a block diagram illustrating an electrical configuration of the battery. In FIG. 1, only an automobile 1 and a battery 20 are illustrated, and other parts configuring the automobile are omitted.

As illustrated in FIG. 1, the automobile (an example of a vehicle) 1 includes the battery 20 which is an energy storage apparatus. As illustrated in FIG. 2, the battery 20 has a block-shaped battery case 21, and an assembled battery 30 including a plurality of cells 31, a circuit board 120, and the like are accommodated in the battery case 21.

In description below, in a case of referring to FIGS. 2 and 3, a vertical direction of the battery case 21 when the battery case 21 is placed horizontally without being inclined with respect to an installation surface is defined as a Y direction, a direction along a long side direction of the battery case 21 is defined as an X direction, and a depth direction of the battery case 21 is defined as a Z direction.

As illustrated in FIG. 3, the battery case 21 includes a box-shaped case main body 23 that opens upward, a positioning member 24 that positions the plurality of cells 31, an inner lid 25 mounted on an upper portion of the case main body 23, and an upper lid 29 mounted on an upper portion of the inner lid 25. In the case main body 23, a plurality of cell chambers 23A in which the cells 31 are individually accommodated are provided side by side in the X direction.

As illustrated in FIG. 3, the positioning member 24 has a plurality of bus bars 24A arranged on an upper surface, and the positioning member 24 is arranged on an upper portion of the plurality of cells 31 arranged in the case main body 23. Therefore, the plurality of cells 31 are positioned and connected in series by the plurality of bus bars 24A.

As illustrated in FIG. 3, the inner lid 25 has a substantially rectangular shape in plan view, and a pair of external terminals 22P and 22N to which a harness terminal (not illustrated) is connected are provided at both end portions in the X direction. A pair of the external terminals 22P and 22N are made from, for example, metal such as a lead alloy, and 22P is for a positive electrode, and 22N is for a negative electrode.

As illustrated in FIG. 3, the circuit board 120 is arranged on an upper surface of the inner lid 25, and the upper side of the circuit board 120 is closed by the upper lid 29.

FIG. 4 is a block diagram illustrating an electrical configuration of the battery 20. The battery 20 includes the assembled battery 30, a voltage measurement unit 41, a current measurement unit 43, a temperature sensor 45, a changeover circuit 50, and a management device 100.

There are, for example, four of the cells 31 of the assembled battery 30 (see FIG. 2), and are connected in four series. The cell is not limited to a prismatic cell, and may be a cylindrical cell or a pouch cell having a laminate film case. The cell 31 is, for example, a lithium ion secondary battery cell.

The assembled battery 30, the current measurement unit 43, and the changeover circuit 50 are connected in series via a power line 35P and a power line 35N.

As illustrated in FIG. 4, the power line 35P connects the external terminal 22P of a positive electrode and a positive electrode of the assembled battery 30. The power line 35N connects the external terminal 22N of a negative electrode and a negative electrode of the assembled battery 30. The external terminals 22P and 22N are terminals for connection with an automobile 10, and can be electrically connected to an auxiliary machine 15 mounted on a vehicle or a vehicle electronic control unit (ECU) 16 via the external terminals 22P and 22N.

The voltage measurement unit 41 can measure cell voltage Vs of each of cells 31A to 31D and total voltage of the assembled battery 30.

The current measurement unit 43 is provided in the power line 35N of a negative electrode. The current measurement unit 43 may be a shunt resistor. The current measurement unit 43 of a resistance type can measure current I of the assembled battery 30 based on voltage across the current measurement unit 43. Alternatively, the current measurement unit 43 may be a magnetic sensor.

The temperature sensor 45 is attached to the assembled battery 30 and detects temperature of or around the assembled battery 30.

The changeover circuit 50 is mounted on the circuit board 120 and is provided on the power line 35P of a positive electrode. The changeover circuit 50 is a circuit that switches output impedance Z of the battery 20. Details of the changeover circuit 50 will be described later.

The management device 100 is mounted on the circuit board 120, and includes a CPU 101, a storage unit 103, and a communication unit 105 as illustrated in FIG. 4. The management device 100 corresponds to “control device” of the present invention. The storage unit 103 stores information for identifying an application of the battery 20. For example, the information is information of a part number of the battery 20.

The management device 100 monitors a state of the battery 20 based on output of the voltage measurement unit 41, the current measurement unit 43, and the temperature sensor 45. That is, the management device 100 monitors the cell voltage Vs of each of the cells 31, temperature of the assembled battery 30, the current I, and total voltage V.

The communication unit 105 is for communication connection with the vehicle ECU 16. The management device 100 can be connected to the vehicle ECU 16 via the communication unit 105, a connector 106, and a communication line 107.

The storage unit 103 stores a monitoring program of the battery 20, a switching program of the output impedance Z, and data necessary for executing these programs. The storage unit 103 further stores information (as an example, a part number) for identifying an application of the battery 20.

The vehicle ECU 16 can determine an application of the battery 20 by reading information (as an example, a part number) for identifying the application from the battery 20 at start of communication with the battery 20 or the like. For example, if a reference table in which a part number and an application are stored in association with each other is held, an application can be identified from a part number. An application of the battery 20 is an auxiliary machine application, an engine start application, or the like.

The program may be stored in a recording medium such as a CD-ROM and used, transferred, lent, or the like. The program may be distributed by using a telecommunication line.

### 2. Switching Control of Output Impedance

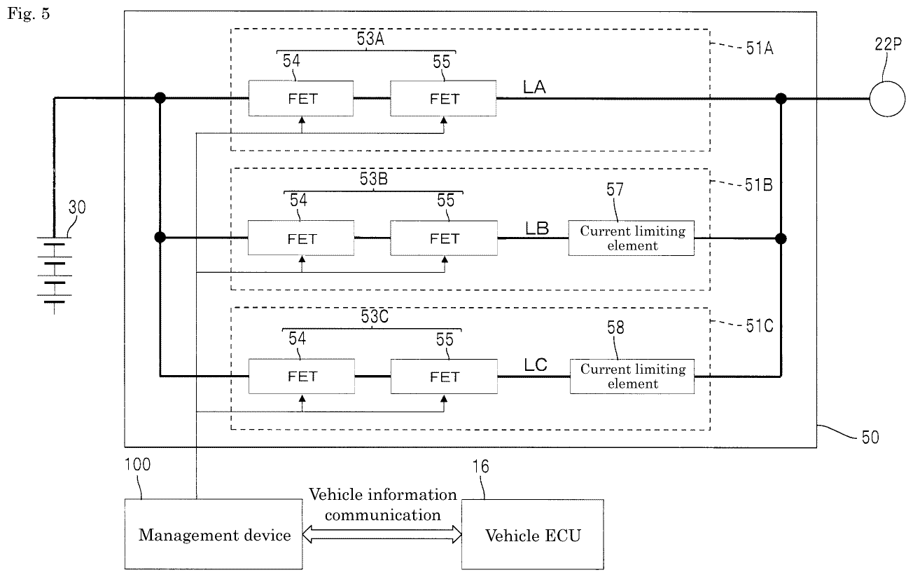

FIG. 5 is a circuit diagram of the changeover circuit 50. The changeover circuit 50 is a circuit that switches the output impedance Z of the battery 20. In this embodiment, the changeover circuit 50 includes three energization circuits 51A to 51C connected in parallel.

The first energization circuit 51A to the third energization circuit 51C include switch circuits 53A to 53C, respectively, and as the switch circuits 53A to 53C are turned off, the energization circuits 51A to 51C can be cut off, and as the switch circuits 53A to 53C are turned on, the energization circuits 51A to 51C can be turned on and allow current to flow.

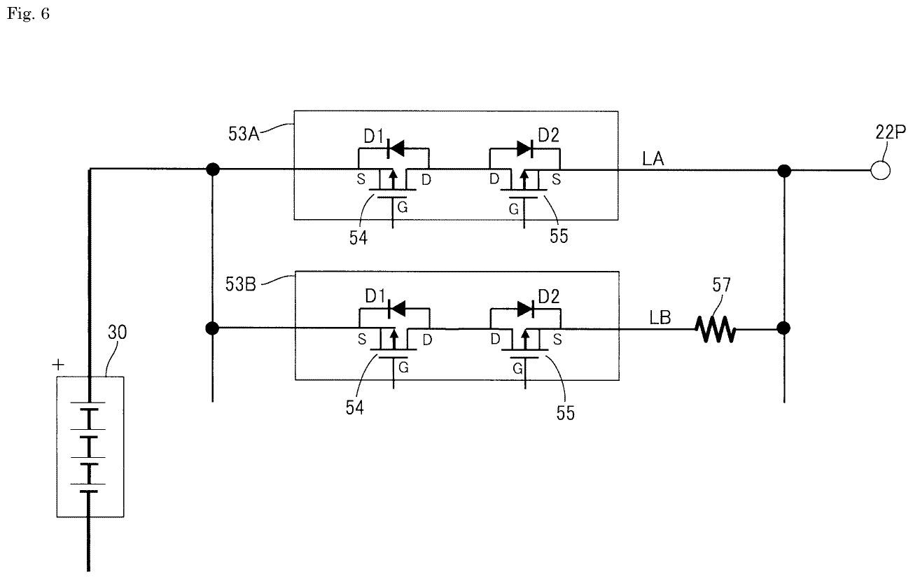

For example, as illustrated in FIG. 6, the switch circuits 53A to 53C can be configured by two field effect transistors (FETs) 54 and 55 connected back-to-back.

As illustrated in FIG. 5, the first energization circuit 51A includes only the switch circuit 53A and does not include a current limiting element. The second energization circuit 51B and the third energization circuit 51C include current limiting elements 57 and 58 in addition to the switch circuits 53B and 53C.

The current limiting element 57 and the current limiting element 58 are resistors. Two of the current limiting elements 57 and 58 have different resistance values, and a resistance value of the current limiting element 58 of the third energization circuit 51C is larger than a resistance value of the current limiting element 57 of the second energization circuit 51B.

That is, in three of the energization circuits 51A to 51B, resistance values of lines LA to LC connecting the external terminals 22P of a positive electrode and a positive electrode of the assembled battery 30 are different. Resistance values of the lines LA to LC increase in the order of the first energization circuit 51A, the second energization circuit 51B, and the third energization circuit 51C, and a resistance value of the line LC of the third energization circuit 51C is the maximum. Resistance values of the lines LA to LC are the sum of resistance of the lines themselves and resistance of current limiting elements provided on the lines.

### (Magnitude Relationship of Line Resistance)

RA<RB<RC
RA: Resistance value of line LA of first energization circuit 51A
RB: Resistance value of line LB of second energization circuit 51B
RC: Resistance value of line LC of third energization circuit 51C

As described above, the output impedance Z of the battery 20 can be switched as the first energization circuit 51A to the third energization circuit 51C are used selectively or in combination.

FIG. 7 illustrates a simple equivalent circuit of the battery 20, and, in the diagram, VC indicates internal electromotive force of the assembled battery 30 and Z indicates output impedance. The output impedance Z is impedance when the battery 20 is viewed from the external terminals 22P and 22N side (when the battery 20 is viewed from an A direction in FIG. 7).

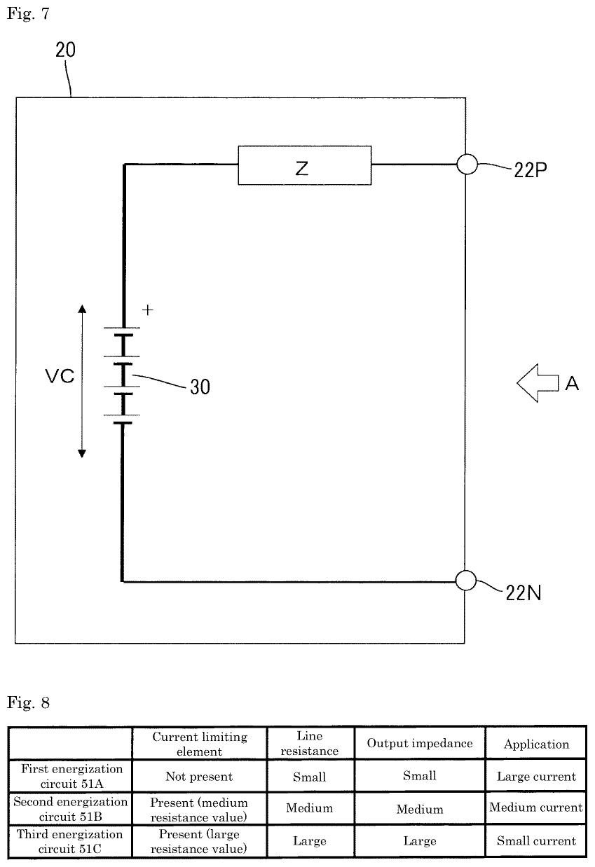

For example, as illustrated in FIG. 8, in a case where the first energization circuit 51A having a small line resistance is selected, the output impedance Z of the battery 20 is small.

On the other hand, in a case where the second energization circuit 51B having a medium line resistance is selected, the output impedance Z of the battery 20 is medium, and in a case where the third energization circuit 51C having a large line resistance is selected, the output impedance Z of the battery 20 is large.

When the output impedance Z is small, current easily flows, and charge and discharge of large current can be performed, and thus, the small output impedance Z is suitable for a large current application. In a case where the output impedance Z is large, current is limited, and thus, the large output impedance Z is suitable for a small current application.

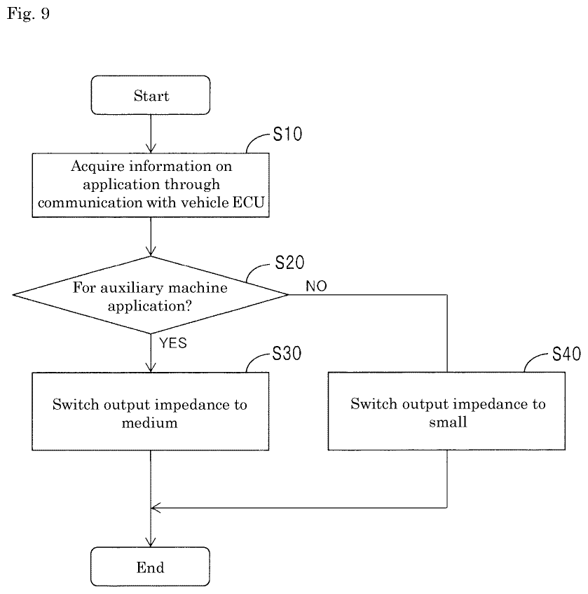

FIG. 9 is a flowchart of switching control of the output impedance Z. Switching control of the output impedance Z includes four steps of S10 to S40, and is executed, for example, with start of communication with the vehicle ECU 16 as the battery 20 is mounted on the vehicle as a trigger.

When switching control of the output impedance Z is started, the management device 100 first accesses the vehicle ECU 16 and acquires information on use of the battery 20 from the vehicle EUC 16. An application of the battery 20 is, for example, an auxiliary machine application, an engine start application, or the like.

An engine start application is a large current application since cranking current of about several hundred A to 1000 A is discharged. An auxiliary machine application is a medium current application since charge and discharge of about several ten A to 500 A are performed.

In a case where the battery 20 is for an auxiliary machine application (for a medium current application), the management device 100 cuts off the first energization circuit 51A, and controls the second energization circuit 51B and the third energization circuit 51C to be ON. By the above, the output impedance Z of the battery 20 used for an auxiliary machine application can be switched to “medium” (S30).

In a case where the battery 20 is for an engine start application (large current application), the management device 100 controls all the first to third energization circuits 51A to 51C to be ON. By the above, the output impedance Z of the battery 20 used for an engine start application can be switched to “small” (S40).

### 3. Effect

According to this configuration, the output impedance Z of the battery 20 can be switched according to an application of the battery 20. For this reason, the battery 20 can exhibit output performance according to the application.

For example, for an engine start application, when the output impedance Z is switched to “small”, current easily flows as compared with a case where the output impedance Z is “medium” or “large”. For this reason, sufficient current necessary for starting an engine can be discharged, and starting performance of the engine can be secured.

For an auxiliary machine application, when the output impedance Z is switched to “medium”, current is less likely to flow as compared with a case where the output impedance Z is “small”. For this reason, Joule heat can be reduced, and heat generation of the battery 20 can be suppressed.

In a battery that is generally used, in a case where short-circuit current exceeding a threshold flows due to an external short circuit or the like, current is cut off by using a relay or the like, so that the battery 20 is protected.

However, in a state where current is cut off, the battery 20 cannot be used, and it may take time and effort because special operation is required to release cut-off of current. Further, since the assembled battery 30 and an external terminal 22 are disconnected, there is also a problem that voltage of the battery 20 cannot be measured.

In this configuration, for an auxiliary machine application, as the output impedance Z is switched to “medium”, current hardly flows as compared with a case where the output impedance Z is controlled to be “small”. For this reason, even if an external short circuit or the like occurs, short-circuit current is less likely to exceed a threshold, so that the chances of cutting off current can be reduced. For this reason, the above problem can be solved.

In the battery 20 described in this embodiment, it is possible to cut off current exceeding a threshold by controlling all of the energization circuits 51A to 51C to be OFF.

### Second Embodiment

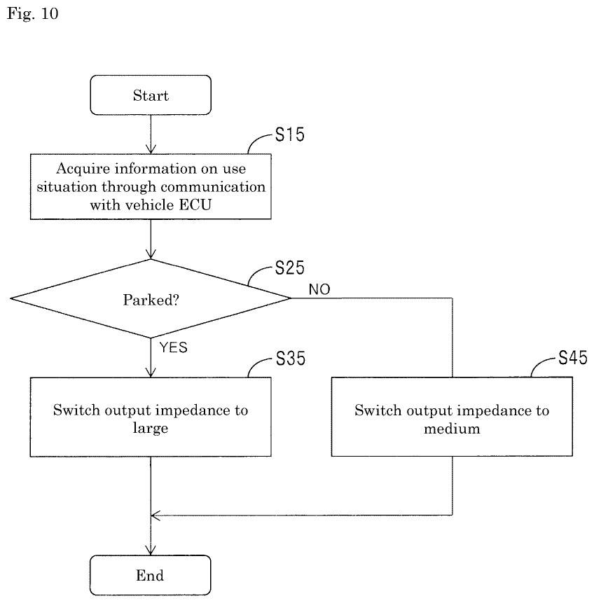

The second embodiment is different from the first embodiment in switching control of the output impedance Z. FIG. 10 is a flowchart of switching control of the output impedance Z in the second embodiment.

The switching control of the output impedance Z includes four steps of S15 to S45, and is executed, for example, at a predetermined cycle after the battery 20 is mounted on a vehicle. In this example, it is assumed that the battery 20 is for an auxiliary machine application.

When switching control of the output impedance Z is started, the management device 100 first accesses the vehicle ECU 16 and acquires information on a state of the automobile 10 from the vehicle EUC 16. Specifically, information indicating whether the automobile 10 is parked or in another state is acquired.

In a case where the automobile 10 on which the battery 20 is mounted is parked (in a case where the battery 20 is used in the parked automobile 10), the management device 100 controls the first energization circuit 51A and the second energization circuit 51B to be OFF, and the third energization circuit 51C to be ON.

By the above, in a case where the automobile 10 on which the battery 20 is mounted is parked, the output impedance Z of the battery 20 can be switched to “large” (S35).

In a case where the automobile 10 on which the battery 20 is mounted is in a state other than a parked state (in a case where the battery 20 is used in an automobile during traveling or the like), the management device 100 cuts off the first energization circuit 51A, and controls the second energization circuit 51B and the third energization circuit 51C to be ON.

By the above, in a case where the automobile 10 on which the battery 20 is mounted is in a state other than a parked state, the output impedance Z of the battery 20 can be switched to “medium” (S45).

In this configuration, the output impedance Z of the battery 20 can be switched according to a use situation of the battery 20. For this reason, the battery 20 can exhibit output performances according to a use situation.

Specifically, in a case where the battery 20 is used in the parked automobile 10 with less charge and discharge, it is possible to suppress output current of the battery 20 by switching output impedance to “large”. Further, in a case where the battery 20 is used in a traveling automobile in which charge from an alternator or discharge to an auxiliary machine is performed, it is possible to perform charge or discharge with current that is suitable for charge or discharge to an auxiliary machine by switching output impedance to “medium”.

### Third Embodiment

In the first embodiment, information on an application of the battery 20 is acquired by communication with the vehicle ECU 16, and the output impedance Z of the battery 20 is switched. In the second embodiment, information on a use situation of the battery 20 is acquired by communication with the vehicle ECU 16, and the output impedance Z of the battery 20 is switched.

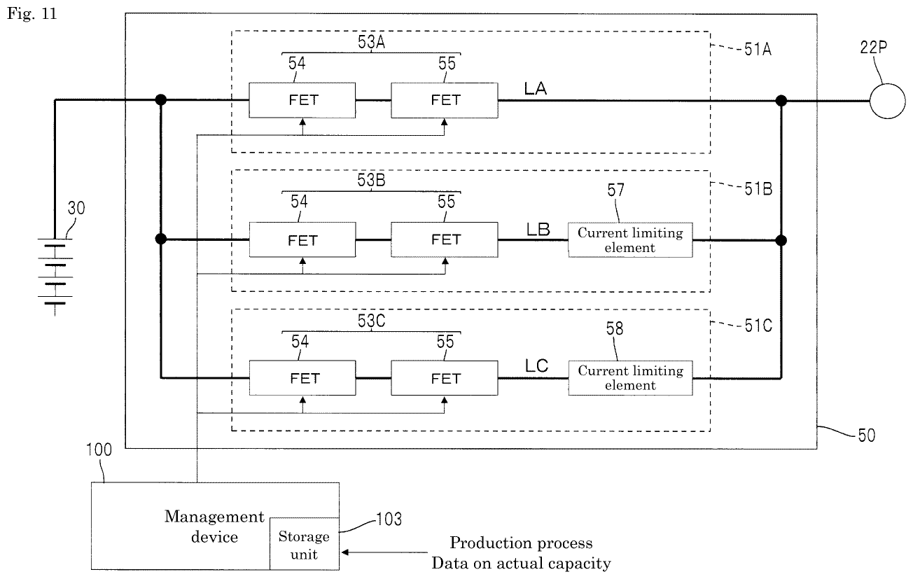

In a third embodiment, as illustrated in FIG. 11, data of actual capacity [Ah] of the battery 20 is written and stored in the storage unit 103 in a production process of the battery 20. In this case, the storage unit 103 is preferably nonvolatile. The actual capacity is an amount of electricity that can be taken out from the battery 20, and is also referred to as full charge capacity [Ah].

After activation, the control device 100 reads data of actual capacity [Ah] from the storage unit 103 and switches the output impedance Z of the battery 20.

For example, the battery 20 having small capacity switches the output impedance Z to “large”, and the battery 20 having medium capacity switches the output impedance Z to “medium”. Further, the battery 20 having large capacity switches the output impedance Z to “small”.

In this configuration, the output impedance Z of the battery 20 can be switched according to magnitude of actual capacity. For this reason, the battery 20 can exhibit output performances according to magnitude of actual capacity. This configuration has an advantage that the battery 20 can autonomously change the output impedance Z even in a case where there is no communication function with a host device such as an automobile.

### Other Embodiments

The present invention is not limited to the embodiment described with reference to the above description and diagrams, and for example, an embodiment below is also included in the technical scope of the present invention.
(1) The cell (repeatedly chargeable and dischargeable energy storage cell) 31 is not limited to a lithium ion secondary battery cell, and may be another nonaqueous electrolyte secondary battery cell. A capacitor can be used instead of the secondary battery cell 31.
(2) In the first to third embodiments described above, the battery 20 for a vehicle is described. In a case of an aspect of the third embodiment, the battery 20 is not limited to be used for a vehicle, and may be used for other applications. For example, the battery 20 may be used for stationary applications such as an energy storage apparatus for fluctuation absorption in a distributed power generating system and an uninterruptible power system (UPS).
(3) In the first embodiment described above, the vehicle ECU 16 determines an application of the battery 20 based on a part number of the battery 20. The configuration is not limited to the above, and an application of the battery 20 may be determined from actual capacity of the battery 20. That is, as exemplified in the third embodiment, if data on actual capacity of the battery 20 is written in the storage unit 103 in a manufacturing process, the vehicle ECU 16 can determine an application of the battery 20 by reading the data on the actual capacity from the battery 20 at start of communication.
(4) In the first embodiment described above, an application of the battery 20 is determined by the vehicle ECU 16; however, if vehicle information (such as a vehicle code for identifying a vehicle) is acquired by communication with the vehicle, an application of the battery 20 can be determined by the battery 20. For example, if the storage unit 103 of the battery 20 stores a reference table in which vehicle information is associated with an application of the battery, the control device 100 can determine an application of the battery 20 as the vehicle information is transmitted from the vehicle ECU 16 to the control device 100.
(5) In the second embodiment described above, in a case where the battery 20 is used in the automobile 10 that is parked, the output impedance Z of the battery 20 is switched to “large”. In addition to this, for example, before the battery 20 is mounted on the automobile 10 (during battery transportation or the like) or in a case where the battery 20 is removed from the automobile 10, the output impedance Z of the battery 20 may be switched to “large”. Attachment and detachment to and from the automobile 10 can be determined from a communication state with the vehicle ECU 16. For example, in a case where communication with the vehicle ECU 16 has never been performed, it can be determined that it is before the battery 20 is mounted on the automobile 10. In a case where there is no communication with the vehicle ECU 16 for predetermined time or more after start of communication with the vehicle ECU 16, it can be determined that the battery 20 is removed from the automobile 10.
(6) In the first to third embodiments described above, the plurality of energization circuits 51A to 51C connected in parallel are shown as an example of the changeover circuit 50 that switches the output impedance Z. The changeover circuit 50 only needs to be able to switch the output impedance Z of the battery 20, and is not limited to the circuit configuration of the embodiment. For example, a circuit using a variable resistor may be used.
(7) In the first to third embodiments described above, the switch circuits 53A to 53C include two FETs. The switch circuits 53A to 53C may have other configurations such as one including a single switch as long as current can be turned on or off.
(8) In the third embodiment, data of actual capacity [Ah] of the battery 20 is written and stored in the storage unit 103 in a production process of the battery 20. Then, when the control device 100 is activated, data of actual capacity is read from the storage unit 103, and the output impedance Z is switched. Other than data of actual capacity, data on an application of the battery 20 may be written and stored in the storage unit 103 in a production process. Then, when the control device 100 is activated, data on an application may be read from the storage unit 103 to switch the output impedance Z.
(9) In the first to third embodiments described above, the changeover circuit 51 includes three of the energization circuits 51A to 51C connected in parallel. Three of the energization circuits 51A to 51C can be used not only for switching the output impedance Z but also for backup at the time of failure (redundancy). For example, in a case where an OPEN failure occurs in the energization circuit 51A during use, it is possible to continue charge and discharge by using the other energization circuits 51B and 51C.
(10) In the first embodiment described above, the output impedance Z is switched according to an application of the battery 20. In the second embodiment, the output impedance Z is switched according to a use situation of the battery 20. The output impedance Z of the battery 20 may be switched according to a type of the automobile 10 without limitation to an application and a use situation of the battery 20. For example, the control device 100 of the battery 20 acquires information on a type of the automobile 10 on which the battery 20 is mounted by communication with the vehicle ECU 16. The control device 100 switches the output impedance Z of the battery 20 to small in a case where the automobile 10 is a vehicle of a type that requires large maximum current, such as a large vehicle. In a case where the automobile 10 is a vehicle of a type that requires small maximum current, such as a small vehicle, the output impedance Z of the battery 20 is switched to large. With this function, the battery 20 can be used for general purposes (common use) between different types of automobiles.
(11) In the first embodiment described above, the output impedance Z is switched according to an application of the battery 20. In the second embodiment, the output impedance Z is switched according to a use situation of the battery 20. The output impedance Z of the battery 20 may be switched according to internal resistance of the assembled battery 30 without limitation to an application and a use situation of the battery 20. For example, by changing (from large to small) the output impedance Z according to a change (from small to large) in internal resistance of the assembled battery 30, total resistance of the battery 20 can be easily kept constant regardless of lapse of time after manufacturing or increase in internal resistance due to use for many years. For this reason, heat generation can be suppressed while power supply capability to a load is maintained. Internal resistance of the assembled battery 30 can be calculated from a measured value of current and terminal voltage of the battery 20. Output impedance of the battery 20 may be switched according to a deterioration state of the battery 20, instead of internal resistance. That is, as deterioration of the battery 20 progresses, the output impedance Z of the battery 20 is decreased, so that the decrease in output performance due to the deterioration can be compensated. A deterioration state of the battery 20 can be determined using, for example, a retention rate of actual capacity (full charge capacity) based on an initial value at the time of manufacture as an index.

1. An energy storage apparatus comprising:
a cell;
a changeover circuit located on a current path of the cell; and
a control device,
wherein the changeover circuit is a circuit that switches output impedance of the energy storage apparatus, and
the control device switches output impedance of the energy storage apparatus by using the changeover circuit according to a predetermined condition.

2. The energy storage apparatus for a vehicle according to claim 1, wherein the control device acquires information on a use situation or information on an application of the energy storage apparatus through communication with a vehicle, and switches output impedance of the energy storage apparatus according to the acquired information.

3. The energy storage apparatus for a vehicle according to claim 1, wherein the control device acquires information on a type of a vehicle through communication with the vehicle, and switches output impedance of the energy storage apparatus according to the acquired information.

4. The energy storage apparatus according to claim 1, wherein the control device includes a storage unit that stores information on an application or information on size of actual capacity of the energy storage apparatus, and switches output impedance of the energy storage apparatus according to information on an application or size of actual capacity of the energy storage apparatus stored in the storage unit.

5. The energy storage apparatus according to claim 1, wherein the control device switches output impedance of the energy storage apparatus according to internal resistance or a deterioration state of the cell.

6. The energy storage apparatus according to claim 1, wherein
the changeover circuit is a plurality of energization circuits connected in parallel,
the plurality of energization circuits have different line resistance, and
the control device switches output impedance of the energy storage apparatus by selection or combination of the energization circuits.
